(19) United States
(12) Patent Application Publication
(10) Pub. No.: US 2014/0118987 A1
(43) Pub. Date: May 1, 2014

(54) Solar Simulator and Ultraviolet Filter System for Use in Solar Simulators

(71) Applicant: Zhuoyun Li, North Grafton, MA (US)

(72) Inventor: Zhuoyun Li, North Grafton, MA (US)

(73) Assignee: Newport Corporation, Irvine, CA (US)

(21) Appl. No.: 14/125,718

(22) PCT Filed: Jun. 14, 2012
(86) PCT No.: PCT/US2012/042550

§ 371 Date: Dec. 12, 2013

Related U.S. Application Data
(60) Provisional application No. 61/498,002, filed on Jun. 17, 2011.

(51) Int. Cl. F21V 9/02; G02B 5/20

(52) U.S. Cl. CPC F21V 9/02; G02B 5/208
USPC 362/2; 359/350

(57) ABSTRACT

The present application is directed to an optical filter system for use in a solar simulator, and includes at least one supplemental filter configured not to transmit light having a wavelength of 295 nm or less and to output at least one conditioned signal at least one WG320 optical filter configured to be irradiated by the conditioned signal and output at least one partially filtered signal having a wavelength of about 300 nm or greater, and at least one UG11 pass filter configured to be irradiated by the partially filtered signal and output at least one output signal having a wavelength of about 300 nm to about 400 nm.

### CROSS-REFERENCE TO RELATED APPLICATIONS

The present application claims priority to U.S. Provisional patent Application Ser. No. 61/498,002, entitled “Ultraviolet Filter System for Use in Solar Simulators and Method of Manufacture,” the entire contents of which are hereby incorporated by reference herein.

### BACKGROUND

Presently, solar simulators are used in a wide variety of applications. For example, light sources capable of reproducing the spectral characteristics of the sun are used in testing the weathering characteristics of various protective coatings such as paints, stains, exterior coatings, and the like. In addition, solar simulators may also be used in research directed at skin cancer, photo-biological applications, photo toxicity testing, photo allergy testing, as well as various other medical applications. For example, solar simulators are frequently used to determine the sun protection factor (hereinafter SPF) of various cosmetics, sun blocks, lotions, clothing, and the like. Typically, the SPF test utilizes the erythemal response of the skin to ultraviolet (UV) radiation. More specifically, the SPF is a ratio calculated from the ultraviolet radiation energies emitted from a solar simulator required to induce a minimum erythemal response with and without sun product applied to the skin of human volunteers. In order to simulate the UV light for SPF test, the solar simulator spectral output must comply with governing standards. Exemplary standards include: FDA Sunscreen Drug Products for Over-the-Counter Human Use, August 2007; International Sun Protection Factor (SPF) Test Method, May 2006 (COLIPA, CTFA, JCIA); and ISO Cosmetics—Sun protection test methods—In vivo determination of the sun protection factor, ISO 24444:2010.

To comply with these standards, the output of the solar simulator must follow a specific profile which defines the Relative Cumulative Erythemal Effectiveness (% RCEE). The International Sun Protection Factor (SPF) Test Method, sometimes referred as COLIPA, defined the spectral requirement for solar simulator as following (FDA and ISO standard are similar):

Measured % RCEE

| Spectral Range (nm) | Lower Limit | Upper Limit |
|---|---|---|
| <290 | | <0.1 |
| 290-300 | 1.0 | 8.0 |
| 290-310 | 49.0 | 65.0 |
| 290-320 | 85.0 | 90.0 |
| 290-330 | 91.5 | 95.5 |
| 290-340 | 94.0 | 97.0 |
| 290-400 | 99.0 | 100.0 |
| UVA II (320-340) | ≧20.0 | |
| UVA I (340-400) | ≧60.0 | |

Historically, this spectral profile is achieved by the combination of a WG320 and UG11 color glass filters manufactured by the Schott Corporation. FIGS. 1A-1C shows a prior art filter system 1 utilizing a WG320 long pass optical filter 3 and a UG11 UV pass optical filter 5. As shown, an input signal 7 having an input spectral profile 13 (See FIG. 1B) is incident on and transmitted through the WG320 filter 3 thereby producing a partially filtered signal 9. The partially filtered signal 9 is then incident on the UG11 filter 5 which transmits an output signal 11 having a desired output spectral profile 15 (See FIG. 1C) therethrough.

While the prior art configuration shown in FIG. 1 has proved to be somewhat useful in the past, a number of shortcoming have been identified. For example, the WG320 color glass needs to be polished to batch specific thickness to compensate for the transmission variation. This polishing process has proven to be a labor-intensive, time-consuming process. Further, the glass manufacturer changed the material used in WG320 filter to meet new environmental regulations. As a result, the desired spectral profile can no longer be reproduced using the combination of a WG320 and UG11 color glass filters. FIGS. 2 and 2A show a graphically the spectral output of a filter system as configured in FIG. 1 which includes a newly formulated WG320 optical filter as compared to the same filter system which incorporates the previously formulated WG 320 optical filter. As shown, in FIG. 2A, the difference between the prior WG320 optical filter and the newly formulated WG320 optical filter is especially obvious at wavelengths from about 290 nm to about 310 nm. As such, many manufacturers of solar simulators and testing companies are relying on limited reserve stocks of previously formulated WG320 filters to manufacture solar simulators. Once the reserve stocks of these WG 320 filters are depleted, manufacturing solar simulators capable of outputting COLIPA testing method standards will prove difficult if not impossible.

Thus, in light of the foregoing, there is an ongoing need for an ultraviolet filter system capable of meeting COLIPA standards for use in solar simulators.

### SUMMARY

The present application discloses various embodiments of solar simulators and optical filter systems for use therein. In one embodiment, the present application is directed to a solar simulator and includes a lamp housing, at least one lamp positioned within the lamp housing and configured to emit multiple wavelength light, at least one lamp reflector positioned within the lamp housing and configured to reflect at least a portion of the light emitted from the lamp out of the lamp housing, at least one optical suite housing coupled to the lamp housing, and at least one optical suite positioned within the optical suite housing. The optical suite includes at least one supplemental optical filter in optical communication with the lamp reflector and configured to filter the multiple wavelength light from the lamp to produce at least one conditioned optical signal, at least one WG320 optical filter in optical communication with the supplemental optical filter and configured to filter the conditioned optical signal to produce at least one partially filtered signal, and at least one UG11 optical filter in optical communication with the WG320 optical filter and configured to filter the partially filtered optical signal to produce at least one output signal having an output signal having a wavelength from about 300 nm to about 400 nm.

In another embodiment, the present application is directed to an optical filter system for use in a solar simulator, and includes at least one supplemental filter configured not to transmit light having a wavelength of 295 nm or less and to output at least one conditioned signal at least one WG320 optical filter configured to be irradiated by the conditioned signal and output at least one partially filtered signal having a wavelength of about 300 nm or greater, and at least one UG11 pass filter configured to be irradiated by the partially filtered signal and output at least one output signal having a wavelength of about 300 nm to about 400 nm.

The present application further discloses an optical filter system for use in a solar simulator which includes at least one supplemental filter configured to output at least one conditioned signal, the supplemental filter configured to transmit light having a wavelength of about 295 nm or greater, at least one long pass optical filter configured to be irradiated by the conditioned signal and output at least one partially filtered signal, the partially filter signal having a wavelength of about 300 nm or greater, and at least one UV pass filter configured to be irradiated by the partially filtered signal and output at least one output signal having a wavelength range of about 300 nm to about 400 nm.

Other features and advantages of the embodiments of the solar simulator and optical filter system for use in a solar simulator as disclosed herein will become apparent from a consideration of the following detailed description.

### BRIEF DESCRIPTION OF THE DRAWINGS

Various embodiments of solar simulator and optical filter systems for use therein will be explained in more detail by way of the accompanying drawings, wherein:

FIG. 1A shows a schematic of a prior art UV filter system for use in a solar simulator;

FIG. 1B shows graphically the spectral characteristics from about 280 nm to about 400 nm of an optical signal prior to filtering using the UV filter system shown in FIG. 1A;

FIG. 1C shows graphically the spectral characteristics from about 280 nm to about 400 nm of an output optical signal following filtering using the UV filter system shown in FIG. 1A;

FIG. 2 shows a graphical representation of the spectral performance of the originally formulated WG320 filter and compared with the newly formulated WG320 filter;

FIG. 2A shows a more detailed graphical representation of the spectral performance of the originally formulated WG320 filter and compared with the newly formulated WG320 filter;

FIG. 3A shows a schematic of a novel optical system for use in a solar simulator;

FIG. 3B shows graphically the spectral characteristics from about 280 nm to about 400 nm of an optical signal prior to filtering using the UV filter system shown in FIG. 3A;

FIG. 3C shows graphically the spectral characteristics from about 280 nm to about 400 nm of an output optical signal following filtering using the UV filter system shown in FIG. 3A;

FIG. 4A shows a schematic of a supplemental optical filter used in the filter system shown in FIG. 3A wherein the supplement optical filter is angularly displaced to a first position from a position normal to incident light;

FIG. 4B shows graphically the spectral characteristics of a supplemental optical filter used in the filter system shown in FIG. 3A wherein the supplement optical filter is angularly displaced to a first position from a position normal to incident light;

FIG. 5A shows a schematic of a supplemental optical filter used in the filter system shown in FIG. 3A wherein the supplement optical filter is angularly displaced to a second position from a position normal to incident light;

FIG. 5B shows graphically the spectral characteristics of a supplemental optical filter used in the filter system shown in FIG. 3A wherein the supplement optical filter is angularly displaced to a second position from a position normal to incident light;

FIG. 6 shows a graphical representation of the spectral profile from about 280 nm to about 400 nm of an output signal from the novel optical filter system shown in FIG. 3A;

FIG. 7 shows a logarithmic representation of the spectral profile from about 290 nm to about 290 nm of an output signal of the novel optical filter system shown in FIG. 3A;

FIG. 8 shows a side view of a solar simulator incorporating the novel optical system therein; and

FIG. 9 shows a more detailed side view of the optical suite of a solar simulator which includes the novel optical filter system therein.

### DETAILED DESCRIPTION

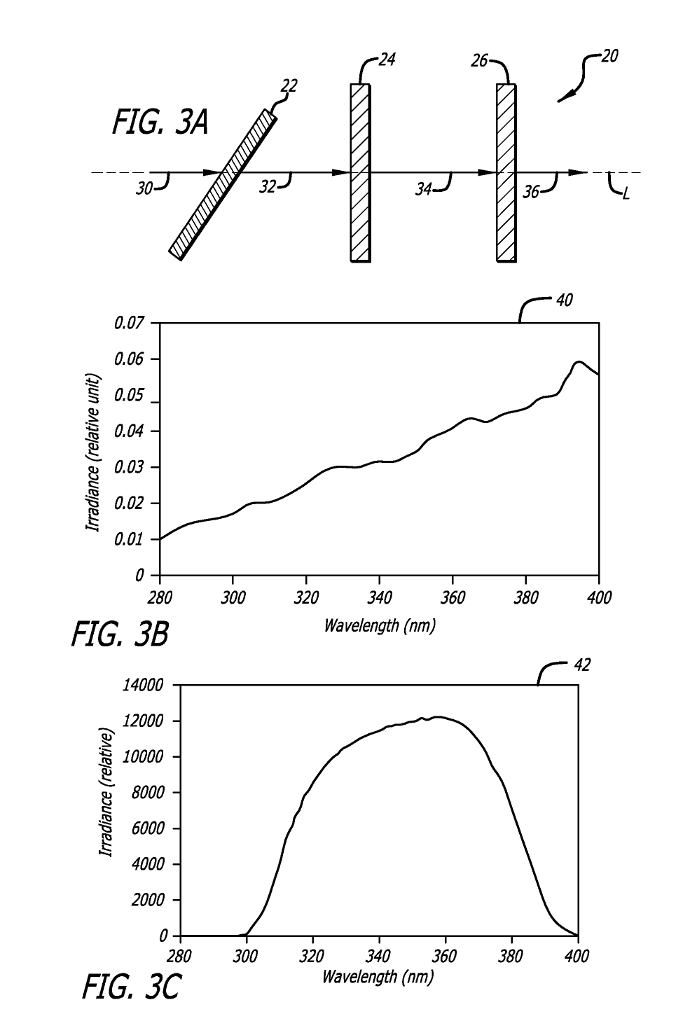

FIG. 3 shows an embodiment of a novel ultraviolet optical filter system for use with a solar simulator. As shown, the filter system 20 includes at least one supplemental wavelength filter or colored glass alternative filter 22, at least one WG320 optical filter 24 or similar performing long pass optical filter, and at least one UG11 optical filter 26 or similar performing UV pass filter. In one embodiment, the supplemental filter 22 comprises a dielectric optical filter configured to pre-condition, attenuate, or otherwise modify at least one optical signal. For example, in one embodiment, the supplemental filter 22 is configured to attenuate, condition, or otherwise modify the spectral profile of the input signal 30 at a desired wavelength. For example, in one embodiment, the supplemental filter 22 is configured to modify the spectral profile of the input signal 30 below about 300 nm. In another embodiment, the supplemental filter 22 is configured to modify the spectral profile of the input signal 30 below about 310 nm. In still another embodiment, the supplemental filter 22 is configured to modify the spectral profile of the input signal 30 below about 400 nm. Optionally, in one embodiment, the supplemental filter 22 comprises at least one Colored-Glass Alternative (CGA) optical filters manufactured by Newport Corporation. In another embodiment, any variety or number of optical filters may be used to form the supplemental optical filter 22. In another embodiment, the supplemental filter 22 may include one or more optical filters, gratings, holographic optical elements, etalons, attenuators, and the like.

As shown in FIG. 3A, the supplemental filter 22 may be positioned such that at least one input signal 30 is first incident thereon. Optionally, the supplemental filter 22 may be positioned anywhere within the novel optical filter system 20. Further, multiple supplemental filters 22 may be positioned in multiple locations within the novel optical filter system 22.

Referring again to FIGS. 3A-3C, an input signal 30 having an input spectral profile 40 (See FIG. 3B) is incident on and transmitted through the supplemental filter 22, thereby producing at least one conditioned signal 32. At least a portion of the conditioned signal 32 is thereafter incident on and transmitted through the WG320 filter 24, thereby generating at least one partially filtered signal 34. Finally, at least a portion of the partially filtered signal 34 is incident on and transmitted through at least one UG11 filter 26 which outputs an output signal 36 having a desired output spectral profile 42 (See FIG. 3C). As shown in FIG. 3C, the present optical system offers considerably better performance from about 285 to about 310 nm as compared with the prior art filter systems. Optionally, any variety of additional optical elements or device may be positioned at any location within the filter system 20. Exemplary additional optical components include, without limitations, lenses, filters, gratings, modulators, mirrors, prisms, sensors, detectors, and the like.

As shown in FIG. 3A, typically the WG320 filter 24 and UG11 filter 2 are positioned substantially normal (perpendicular) to the optical axis L. In contrast, the supplemental filter 22 may be angularly displaced from a position normal to the optical axis L.

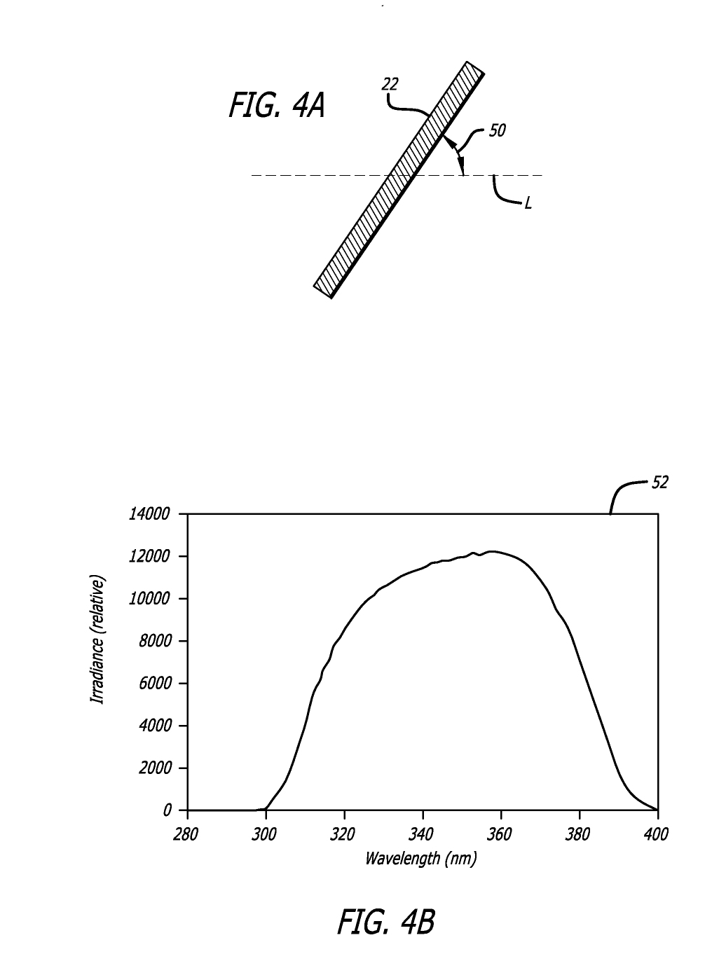

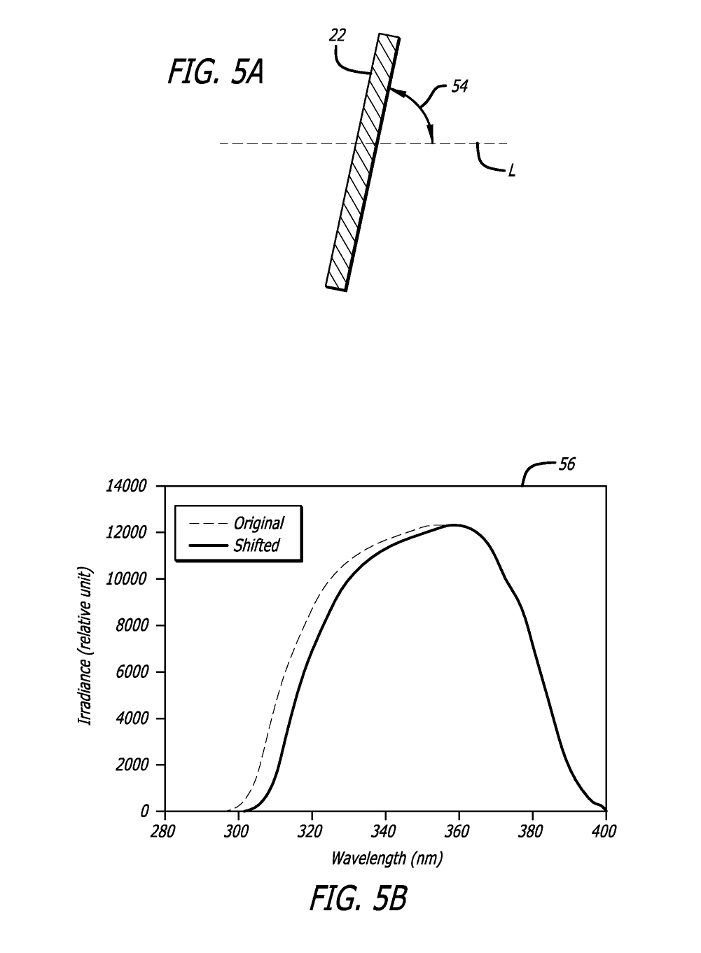

FIGS. 4A-4B and 5A-5B graphically illustrate the effect of changing the angular displacement of the supplemental filter 22 relative to the optical axis L. As shown in FIG. 4A, the supplemental filter 22 may positioned at a first angular displacement 50 from the optical axis L which results in the generation of a first conditioned signal 52 having a spectral profile as shown in FIG. 4B. In contrast, as shown in FIG. 5A, the supplemental filter 22 may be positioned at a second angular displacement 54 from the optical axis L which results in the generation of a second conditioned signal 56 having a spectral profile as shown in FIG. 5B. As such, the spectral profile of the conditioned signal 32 may be varied by increasing or decreasing the angular displacement of the supplemental filter 22 relative to the optical axis L. In one embodiment, the supplemental filter 22 is positioned on a rotatable optical stage thereby permitting the user to vary the spectral profile of the conditioned signal 32. In another embodiment, the supplemental filter 22 may be positioned on a rotatable stage in communication with at least one controller, detector, sensor, or the like. As such, the optical filter system 20 may be configured to operate as an automated system.

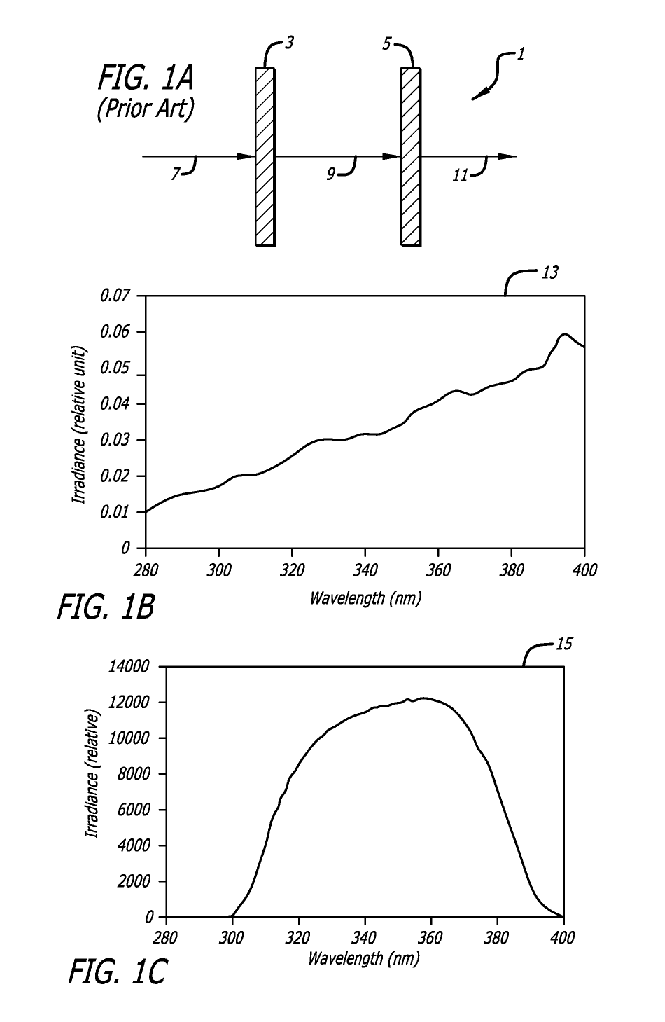

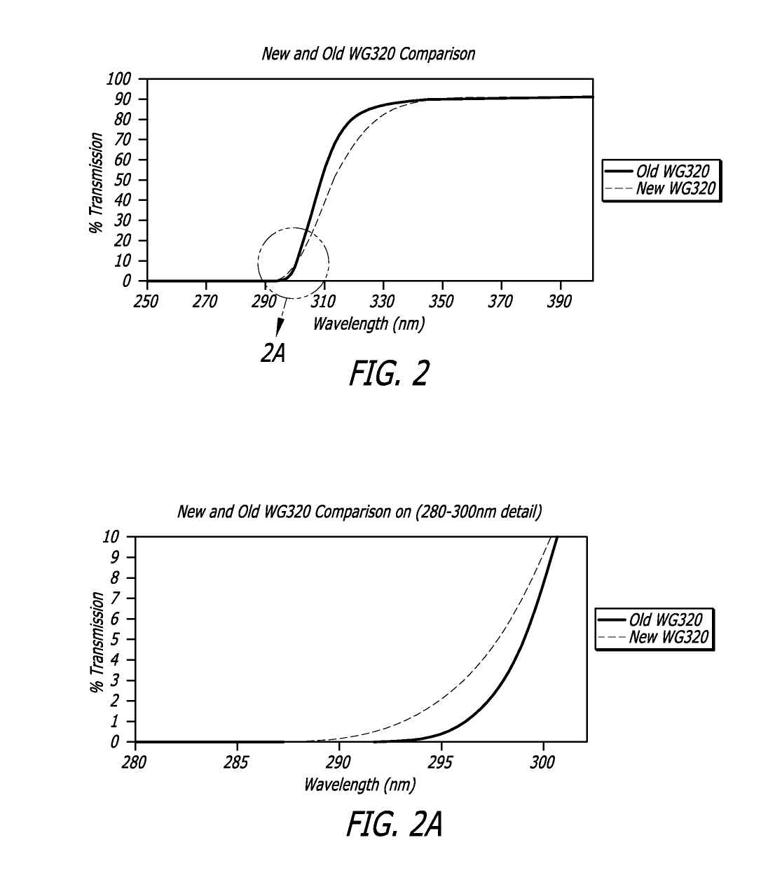

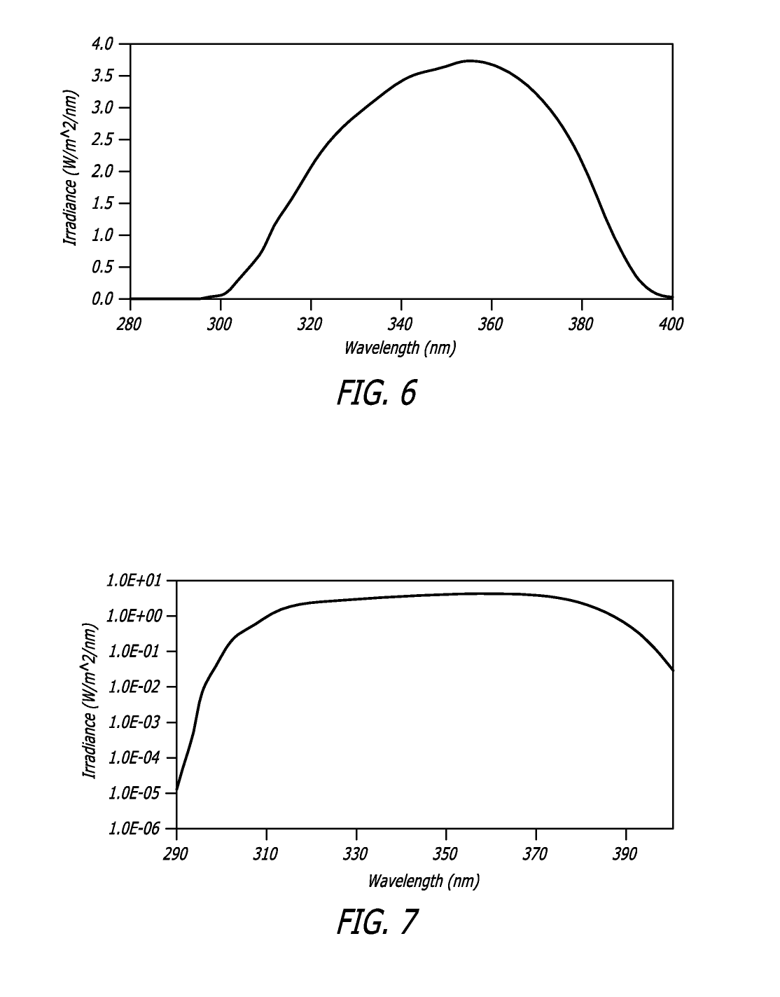

FIGS. 6 and 7 show various graphical representations of the output of the novel optical filter system 20 shown in FIG. 3A. FIG. 6 shows the spectral profile from about 280 nm to about 400 nm of the output signal 36. In contrast, FIG. 7 show a more detailed logarithmic representation of the spectral profile from about 290 nm to about 290 nm of the output signal 36 of the novel optical filter system 20. As shown, the spectral profile of the output signal 36 produced by the novel filter system 20 substantially reproduces the output spectral profile 15 of the output signal 11 of prior art system 1 incorporating the original formulated WG320 optical filters 3 (see FIG. 1).

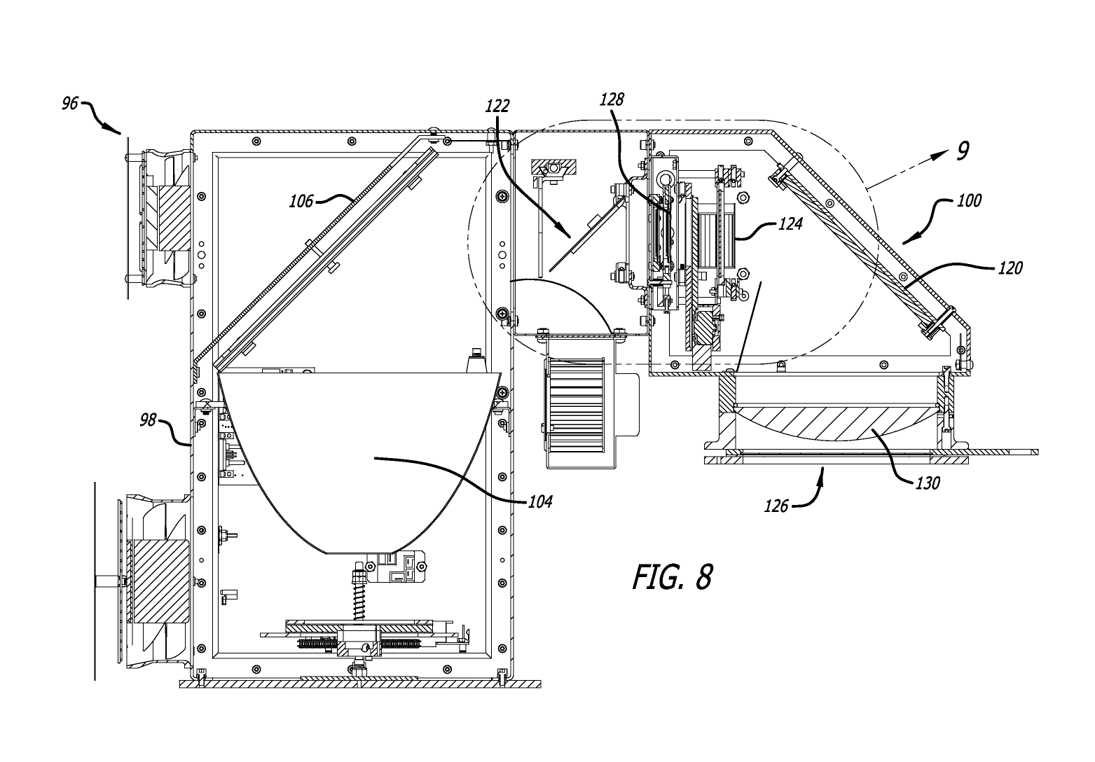

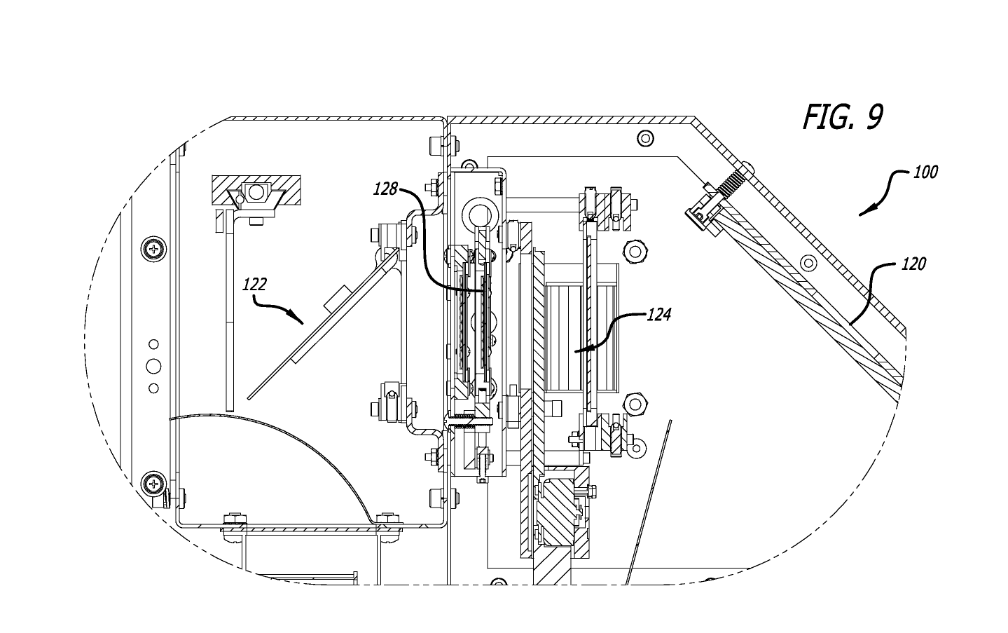

FIGS. 8 and 9 show an embodiment of a solar simulator incorporating the novel optical filter system 20 disclosed herein. As shown, the solar simulator 96 includes a lamp housing 98 and an optical suite housing 100. The lamp housing 98 includes at least one lamp or similar light source 104 positioned therein. In one embodiment, the lamp 104 comprises a Xenon light source configured to emit multiple wavelengths light. Optionally, any variety of light sources configured to emit having any variety of spectral profiles may be used. Further, multiple lamps 104 may be positioned within the lamp housing 98. For example, the lamp housing 98 may contain a first lamp and a second lamp. Optionally, in multiple lamp configurations, the lamps may be the same type lamp or may be different. In one embodiment, the first lamp may be configured to emit light having a first spectral profile or wavelength spectrum while the second lamp is configured to emit light having a second spectral profile or wavelength range.

Referring again to FIGS. 8 and 9, at least one reflector 106 is positioned within the lamp housing 98 and configured to reflect at least a portion of the light from the lamp 104 out of the lamp housing 98. Those skilled in the art will appreciate that any variety of devices may be used to form the reflector, including, for example, mirrors, gratings, and the like.

As shown in FIGS. 8 and 9, at least one optical suite housing 100 is coupled to the lamp housing 98. In one embodiment, the optical suite housing 100 is detachably coupled to the lamp housing 98. In another embodiment, the optical suite housing 100 is non-detachably coupled to the lamp housing 98. The optical suite housing 100 includes at one supplemental or CGA filter 122 in optical communication with the lamp 104 via the reflector 106. As stated above, the CGA filter 122 is configured to condition or attenuate at least a portion of the spectral profile of incident light. In one embodiment, the supplemental filter is positioned normal to the incident light. In an alternate embodiment, the supplemental filter 122 is angularly displaced from a position normal to the incident beam. Optionally, the supplemental filter 122 may be positioned on a rotatable stage within the optical suite housing, thereby permitting the user to tailor the performance of the supplemental filter 122 as desired.

Referring again to FIGS. 8 and 9, at least one WG320 filter 124 is positioned within the optical suite housing. As shown, the WG320 filter is positioned normal to the incident light and is in optical communication with the supplemental filter 122. Light transmitted through the WG320 filter is then incident on an optical suite reflector 120 which reflects the partially filtered light to the UG11 filter 126. In one embodiment, at least one of the WG320 filter 124 and the UG22 filter 126 may be easily removed and changed by the user. Optionally, the WG320, UG11, or both filters may not be easily changed by a user. Finally, the light is emitted from the optical suite housing 100 and directed to a work surface.

As shown in FIGS. 8 and 9, optionally, additional optical elements may be positioned within any portion of the solar simulator 96. For example, as shown in FIG. 8, at least one homogenizer 128 is positioned within the optical suite housing. In addition, at least one lens 130 may be used to focus the output beam to a desired location. Those skilled in the art will appreciate that any variety of devices or optical elements may be used within the present system, including, without limitations, lenses, mirrors, gratings, detectors, optical filters, and the like.

Those skilled in the art will appreciate that various elements thereof may be positioned at various locations throughout the system. For example, the supplemental filter 22, WG320 filter 24, and UG11 filter 26 (See FIG. 3A) may be rearranged in any desired configuration. In addition, any variety of other optical device, components, or elements may be included within the filter system 20, including, without limitations, controllers, rotatable stages, movable stages, lenses, prisms, etalons, filters, gratings, detectors, sensors, modulators, attenuators, and the like. As such, embodiments disclosed herein are illustrative of the principles of the invention. Other modifications may be employed which are within the scope of the invention. Accordingly, the devices disclosed in the present application are not limited to that precisely as shown and described herein.

What is claimed:

1. A solar simulator system, comprising:
a lamp housing;
at least one lamp positioned within the lamp housing and configured to emit multiple wavelength light;
at least one lamp reflector positioned within the lamp housing and configured to reflect at least a portion of the light emitted from the lamp out of the lamp housing;
at least one optical suite housing coupled to the lamp housing;
at least one optical suite positioned within the optical suite housing, the optical suite having
at least one supplemental optical filter in optical communication with the lamp reflector and configured to filter the multiple wavelength light from the lamp to produce at least one conditioned optical signal;
at least one WG320 optical filter in optical communication with the supplemental optical filter and configured to filter the conditioned optical signal to produce at least one partially filtered signal; and
at least one UG11 optical filter in optical communication with the WG320 optical filter and configured to filter the partially filtered optical signal to produce at least one output signal having an output signal having a wavelength from about 300 nm to about 400.

2. The solar simulator system of claim 1 wherein the lamp comprises a Xenon lamp.

3. The system of claim 1 wherein the supplemental optical filter comprises a dielectric optical filter.

4. The system of claim 1 wherein the supplemental optical filter is positioned normal to light thereon.

5. The system of claim 1 wherein the supplemental filter is angularly displaced from a position normal to light incident thereon.

6. The system of claim 5 wherein the supplemental filter is positioned on a rotatable stage.

7. The system of claim 1 further comprising at least one homogenizer located between the supplemental filter and the WG320 filter.

8. The system of claim 1 further comprising at least one lens positioned within the optical suite housing.

9. An optical filter system for use with a broadband light source, comprising:
at least one supplemental filter configured not to transmit light having a wavelength of 295 nm or less and to output at least one conditioned signal;
at least one WG320 optical filter configured to be irradiated by the conditioned signal and output at least one partially filtered signal having a wavelength of about 300 nm or greater; and
at least one UG11 pass filter configured to be irradiated by the partially filtered signal and output at least one output signal having a wavelength of about 300 nm to about 400 nm.

10. The optical filter system of claim 9 wherein the supplemental filter comprises a dielectric filter.

11. The optical filter system of claim 10 wherein the supplemental filter is positioned normal to light incident thereon.

12. The optical filter system of claim 10 wherein the supplemental filter is configured to be angularly displaced from a position normal to light incident on the supplemental filter.

13. The system of claim 12 wherein the supplemental filter is positioned on a rotatable stage.

14. An optical filter system for use in a broadband light source, comprising:
at least one supplemental filter configured to output at least one conditioned signal, the supplemental filter configured to transmit light having a wavelength of about 295 nm or greater;
at least one long pass optical filter configured to be irradiated by the conditioned signal and output at least one partially filtered signal, the partially filter signal having a wavelength of about 300 nm or greater; and
at least one UV pass filter configured to be irradiated by the partially filtered signal and output at least one output signal having a wavelength range of about 300 nm to about 400 nm.

15. The optical filter system of claim 14 wherein the supplemental filter comprises a dielectric filter.

16. The optical filter system of claim 14 wherein the supplemental filter is positioned normal to light incident thereon.

17. The optical filter system of claim 14 wherein the supplemental filter is configured to be angularly displaced from a position normal to light incident on the supplemental filter.

18. The system of claim 17 wherein the supplemental filter is positioned on a rotatable stage.
